(19) United States
(12) Patent Application Publication
(10) Pub. No.: US 2026/0099357 A1
(43) Pub. Date: Apr. 9, 2026

(54) TASK-RELATED CONTEXT FOR DATA TRANSFERS

(71) Applicant: Capital One Services, LLC, McLean, VA (US)

(72) Inventors: Jeremy GOODSITT, Champaign, IL (US); Galen RAFFERTY, Mahomet, IL (US); Michael DAVIS, Arlington, VA (US); Taylor TURNER, Richmond, VA (US); Justin AU-YEUNG, Somerville, MA (US); Owen REINERT, Queens, NY (US)

(73) Assignee: Capital One Services, LLC, McLean, VA (US)

(21) Appl. No.: 18/907,289

(22) Filed: Oct. 4, 2024

(51) Int. Cl. G06F 9/48; G06F 9/30

(52) U.S. Cl. CPC G06F 9/4881; G06F 9/30156

(57) ABSTRACT

Described herein are systems, methods, and programming for facilitating user-specific data transfers to provide task-related context to a user. In response to receiving a request to execute a computing task, one or more artificial intelligence models may generate a representation of the request encoding information about the request. The artificial intelligence models may identify another representation of another request that is similar to the generated representation. The similarity may indicate that another user previously submitted a request to execute a computing task that is similar to the requested computing task. This other representation may be selected and provided to a requesting user's device with a data transfer program configured to cause a decoder implemented by the requested user's device to extract the information encoded by the provided representation. The requesting user can use the extracted information to execute the computing task.

### BACKGROUND

Knowledge Transfer (KT) refers to a technique used to train artificial intelligence models by transferring knowledge from a source domain to a target domain. Transfer Learning (TL) refers to an approach to KT whereby a model pre-trained on a large dataset from the source domain is fine-tuned on a smaller, targeted dataset from the target domain. TL allows the model to extract low-level features from the source domain dataset and leverage these extracted features to detect complex patterns and information from the target domain dataset. However, these data transfer processes are generic and not specific to a given user or computing task to be performed. This results in a variety of technical problems, such as wasted computing resources to train and execute models, decreased model performance, and increased memory footprint.

### SUMMARY

Methods and systems are described herein for novel uses and/or improvements to artificial intelligence applications. As one example, methods and systems are described herein for facilitating improved user-specific data transfers by providing task-related context to a user. These methods and systems can improve efficiency and performance, particularly when performing computing tasks, such as fine-tuning a model, updating training data, executing queries, formatting data, and others.

To solve some or all of the described technical problems, one or more an artificial intelligence models are developed and deployed to leverage artificial intelligence models to improve the KT process. In particular, artificial intelligence models can be trained to identify occurrences of users who previously submitted requests to execute computing tasks that are the same or similar to a computing task to be executed by a user. Upon identifying such a user (or users), a representation of that user may be retrieved and provided to the requesting user. A decoder implemented by the request user's device via a data transfer program may be used to extract, from the provided representation, information associated with the provided representation's corresponding computing task. This information can be used by the requesting user to execute the computing task. Thus, the described techniques enable execution of data transfers that are more specific and useful to the requesting user and/or task, thereby reducing wasted computing resources and time used to train and execute models, improving model performance by using relevant information to execute the computing task (e.g., using pre-determined fine-tune training data for fine-tuning a model), and decreasing memory consumption for datasets of data items not relevant to the requested computing task.

As an illustrative example, a user seeking to fine-tune an artificial intelligence model may benefit from data identified by other users as being helpful and/or important when training the artificial intelligence model. However, unless that data is included in a read-me file or other model note, the user may be unaware of the data. Thus, the user can waste countless hours, computing resources, memory, and the like, attempting to execute a task that could have easily been executed had the proper knowledge been made available to the user. To overcome this technical problem, some embodiments include providing a request to a computing system, where the request corresponds to a request to execute a computing task (e.g., perform a fine-tuning training step, etc.). The computing system may determine, using a trained classification model, a class of the computing task by determining a task type of the computing task (e.g., “Task Type”=“Fine-Tune Training”). The request, the class, information about the user and/or the user's requesting device, can be input to a trained transformer model to generate an embedding. The trained transformer model can compare the generated embedding to other embeddings representing previously submitted requests from other users to execute computing tasks to generate similarity scores indicating how similar the embedding is to one (or more) of the other embeddings. The embedding satisfying a threshold similarity condition (e.g., the similarity score indicating a similarity between the submitted request and a previously submitted request exceeds a threshold similarity score) may be used to identify a corresponding user associated with the previously submitted request. The embedding created for that user's computing task, representing the sequence of events associated with the execution of the computing task, may be provided to the user. As an example, the other user may have performed a similar fine-tuning training step when training an instance of the artificial intelligence model. However, that user may have accessed a set of data items (e.g., code libraries, training data) when executing their corresponding computing task. The embedding representing that user's request may include an indication some or all of the events that occurred while that user executed the computing task. These events, for example, may include data items retrieved and used to perform fine-tuning training. By extracting information from the other user's embedding (e.g., including the data items or mechanisms to access the data items), the requesting user can avoid the technical problems mentioned previously, and perform an improved and expedited execution of their computing task. In some examples, a data transfer program may be executed by the user's device, via a decoder implemented thereon, to extract the information from the similar embedding.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for facilitating user-specific data transfers to provide task-related context to a user, in accordance with one or more embodiments.

FIG. 2 shows an illustrative diagram of example artificial intelligence models, in accordance with one or more embodiments.

FIG. 3 shows illustrative components for a system used to facilitate user-specific data transfers to provide task-related context to a user, in accordance with one or more embodiments.

FIG. 4 shows a flowchart of a process including steps involved in facilitating user-specific data transfers to provide task-related context to a user, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

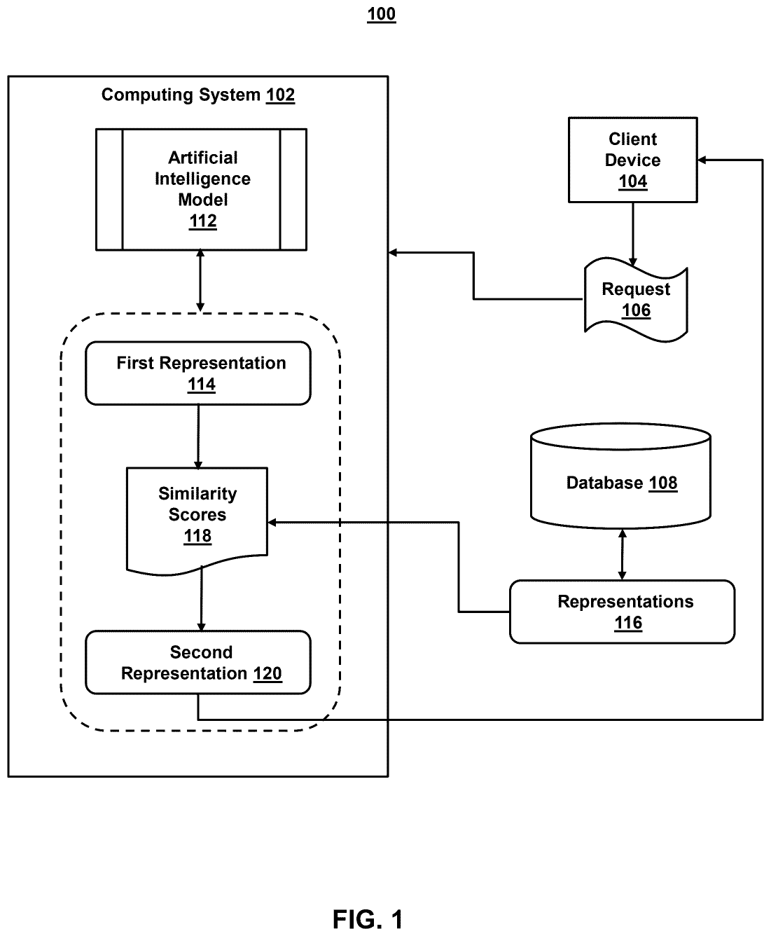

FIG. 1 shows an illustrative system 100 for facilitating user-specific data transfers to provide task-related context to a user, in accordance with one or more embodiments. For example, system 100 may indicate one or more computing systems for executing the user-specific data transfers. For example, FIG. 1 illustrates a computing system 102 configured to implement an artificial intelligence model to identify users who previously submitted requests to execute computing tasks that are the same or similar to a computing task to be executed by a user. Using the artificial intelligence model, computing system 102 may determine the most similar user and/or task. A representation of a request associated with that similar user/task may be retrieved and provided to the user's client device (e.g., client device 104). A decoder implemented by the client device may decode the representation to extract information to be used, by the client device, to execute the computing task. As such, system 100 can execute data transfers that are more specific to the user and/or task, thereby reducing wasted computing resources used to train and execute models, improving model performance, and decreasing memory consumption for datasets of data items not relevant to the requested computing task.

As mentioned above, system 100 may include computing system 102. In some embodiments, computing system 102 may communicate with one or more client devices, such as client device 104, one or more databases, such as database 108, or other devices, systems, servers, or combinations thereof. Furthermore, while a single instance of computing system 102, client device 104, and database 108 are depicted in FIG. 1, persons of ordinary skill in the art will recognize that this is merely illustrative, and additional computing systems, client devices, databases, or other components, may be included in system 100.

In some embodiments, computing system 102 may be configured to receive, from client device 104, a first request, such as request 106, to execute a first computing task. A computing task refers to an executable action performed using one or more computing components (e.g., processors). Some example computing tasks include, but are not limited to, executing an artificial intelligence model for inferences, training an artificial intelligence model, executing a database query, performing an information retrieval step, formatting content, launching/deploying a software application, or other tasks. In some cases, client device 104 may execute the computing task, however one or more external computing resources (e.g., cloud computing resources) can be employed by client device 104 to execute the computing task.

In some embodiments, request 106 may include additional information. This additional information may correspond to information about client device 104 (e.g., an IP address, an operating system identifier, storage capabilities, etc.), a user associated with client device 104 (e.g., user credentials, user preferences, user profiles, etc.), and the like. For example, client device 104 may be associated with a first user, and information related to the first user may be provided with request 106. In some embodiments, if the user that submitted request 106 is an existing user (i.e., a user that has previously submitted a request to computing system 102 via client device 104), previously generated representations, encoding information about previously submitted requests from that user, may be accessed (e.g., from database 108). In some examples, a new user (i.e., whereby request 106 corresponds to a first request submitted by client device 104), may not have any known data items associated therewith.

The relevant data items may refer to data items, or identifiers of data items, that have been tagged as being relevant to one or more previously performed computing tasks. For example, a code library, training data set, update to a training data set, configuration parameters, and the like, used by another user when performing a computing task that is the same or similar as that of the computing task being performed by a current user. Therefore, it may be beneficial to provide those data items to the user prior to the user performing the computing task to improve efficiency and speed. In some embodiments, the data items may be automatically downloaded to the user's client device or a computing environment where the computing task is being performed. The data items may alternatively or additionally be provided as links to web resources whereby the user can access the data items. In some embodiments, the data items may include configurations for executing the computing task. For example, the data items may include tunings for model parameters, hyperparameters, and the like. As yet another example, the configurations may include settings and/or formats for rendering content, such as display preferences, data presentation orderings, and the like.

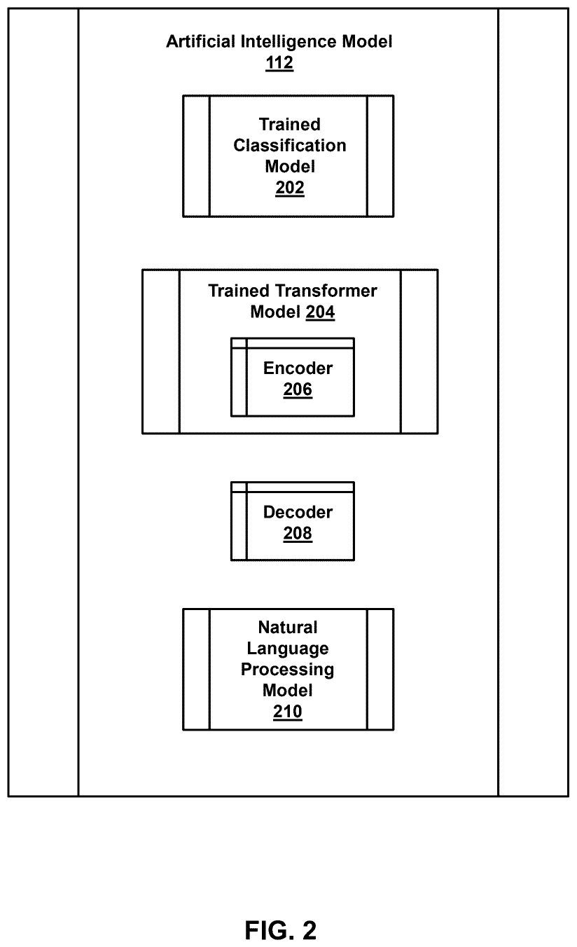

In some embodiments, computing system 102 may be configured to determine a class associated with the first computing task using one or more artificial intelligence models, such as artificial intelligence model 112. Artificial intelligence model 112 is depicted as a single model for illustrative purposes and may include multiple models that work to perform individual functions or work collaboratively (i.e., as an ensemble model). As an example, with reference to FIG. 2, artificial intelligence model 112 may include a trained classification model 202. The trained classification model may be used to determine a class associated with the first computing task. The class may indicate a task type of the computing task. For example, if the task type is “Task=Execute Model,” then the class may be a model execution class (e.g., “Class”=“Model Execution”). In some examples, certain data items may be associated with the identified class. For example, if the class is the model execution class, one or more data items, such as code libraries, scripts, memory allocations, and the like, may be identified as being relevant to the computing task. Different classes may be associated with different sets of data items. Some data items may be associated with multiple classes. These data items may be provided to client device 104 upon determination of the class and/or upon extraction of information of a retrieved embedding of a user that previously performed a similar/same computing task.

In some cases, however, artificial intelligence model 112 may bypass trained classification model 202. For example, artificial intelligence model 112 may include a retrieval-augmented generation (RAG) system. As another example, an interface may be provided that allows a classification to be selected/input.

Trained classification model 202 may be a binary classifier, classifying requests into either a first class or a second class. Trained classification model 202 may, alternatively, perform multi-class classification for larger numbers of classes. Trained classification model 202 may be trained using supervised learning techniques, such as linear regression, Naïve Bayes, support vector machines (SVMs), k-NN, random forests, decision trees, and the like. Some machine learning networks can also be used, such as convolutional neural networks (CNNs), multilayer perceptron (MLP), and deep neural networks (DNNs). Still further, unsupervised learning approaches can be used to train autoencoder networks to perform classification tasks.

In some embodiments, to determine the class, computing system 102 may be configured to identify a task type of the first computing task (e.g., to execute a script, format an application, retrieve data items, compile code, etc.). Computing system 102 may select the class based on the identified task type of the first computing task. For example, a first task type can indicate that a given computing task is to be classified into a first class, a second task type can indicate that a given computing task is to be classified into a second class, and the like. In some examples, a given class may include one or more task types of different computing tasks.

Returning to FIG. 1, in some embodiments, computing system 102 may be configured to generate, using one or more artificial intelligence models, such as artificial intelligence model 112, a first representation 114 of the first request (e.g., request 106). The first representation can encode the request, including the class and/or information associated with the class (e.g., a class identifier, one or more attributes of the class, one or more related classes). With reference again to FIG. 2, artificial intelligence model 112 may include a trained transformer model 204. Computing system 102 may be configured to generate first representation 114 using trained transformer model 204.

First representation 114, in some cases, may include a first embedding representing the first request. For example, trained transformer model 204 may include an encoder 206 trained to generate embeddings representing requests. In this example, first representation 114 may correspond to a first embedding representing request 106. Encoder 206 may generate embeddings representing submitted requests by encoding information associated with those requests. For example, encoder 206 may encode information, such as information related to the first computing task, the first user, and the like, when generating the first embedding (e.g., first representation 114).

In some examples, trained transformer model 204 may include multiple encoders, each configured to encode data associated with a particular class of computing task. A routing device may be employed, in some examples, to route a request to an appropriate encoder based on the identified class of the request. The encoders may include one or more multi-headed attention mechanisms, one or more feed-forward networks, one or more pooling layers, or other components. In some examples, trained transformer model 204 may include one or more decoders. After training has completed, trained transformer model 204 may deploy encoder 206 to generate the representations. In some examples, trained transformer model 204 may include an instance of a decoder 208, as detailed below. Decoders, such as decoder 208, may additionally or alternatively be deployed to client devices, such as client device 104, for decoding the representations. The decoders may also include one or more multi-headed attention mechanisms, feed-forward networks, pooling layers, and the like. The encoder (e.g., encoder 206) may be configured to map an input sequence into a representation encoding information learned about the input. In other words, first representation 114 represents a transformation of request 106 that stores the encoded information and is capable of being used to form predictions and make determinations. The decoder, such as decoder 208, may be configured to decode the representation to extract the encoded information.

As mentioned above, encoder 206 may generate representations of the request. In some cases, the request, such as request 106 of FIG. 1, may include time series data representing a sequence of events of the user. Each event may correspond to an interaction of the user. In some embodiments, the sequences may evolve in time as more user interactions are detected. In some cases, the request may additionally or alternatively include text, such as one or more n-grams, character strings, and the like. Encoder 206 may generate a representation, such as an embedding, by converting the sequence into a learned representation of the sequence in a multi-dimensional space (e.g., an embedding space). Encoder 206 maps the various items in the sequence to tokens including numerical values representing those items.

Encoder 206 may also append each token with a positional encoding. The positional encoding preserves contextual information about the token with respect to the rest of the sequence. For example, with a text string, the positional encoding may preserve the ordering of the text (i.e., which word came first, second, etc.). As another example, with respect to sequences of events, the positional encoding may preserve the order of the events in the sequence (i.e., which event came first, second, etc.).

Encoder 206 may include a multi-headed attention applying self-attention to the sequence. The self-attention allows encoder 206 to recognize associations of words/events to one another and the rest of the sequence. To compute the attention, vector representations of each work token/event token may be generated and multiplied by each other vector representation to produce an attention matrix. The attention matrix encodes the importance of each work/event to the sequence so that accurate decoding, such as using decoder 208, can occur.

Decoder 208 may translate the generated embedding into a sequence of text and/or a sequence of events, depending on the input sequence. Decoder 208 may also include similar components as that of encoder 206 (e.g., multi-headed attention mechanisms, feed-forward networks, etc.). Decoder 208 may also include a classification layer. Decoder 208 works, at a high level, in reverse of encoder 206; identifying the most important text/event token pairs and reconstructing the sequence based on the identified token pairs. The reconstructed sequence can then be classified into one or more sample requests each representing a corresponding computing task.

Returning to FIG. 1, in some embodiments, computing system 102 may be configured to identify, using the artificial intelligence models, such as artificial intelligence model 112, a second user that previously submitted a second request associated with a second computing task. The second user can be selected based on a determination that a similarity score, computed by comparing first representation 114 with representations of requests previously submitted by other users, satisfies a threshold similarity condition. Alternatively, the second user may be chosen without determining the similarity score (e.g., randomly). In some embodiment, computing system 102 may be configured to retrieve a plurality of representations 116 from database 108. Database 108 may store previously submitted requests and/or representations 116 representing those previously submitted requests. Each previously submitted request may include a computing task that was to be executed. The previously submitted requests may also include additional information, such as information regarding a user that submitted the request, information regarding the client device used to submit the request, information regarding the class of the request, or other information, or combinations thereof. In some examples, the previously submitted requests may include metadata tags indicating a data item or items that are relevant to the computing task. These data items may represent data items accessed by a corresponding user when the computing task (for which they previously submitted a request) was executed. In some examples, these data items may be selected as “relevant” based on a determination that those data items were interacted with by the corresponding user during their execution of the computing task. Representations 116 may encode this information and/or metadata (e.g., as an embedding).

For example, a document accessed and scrolled through while a given computing task is performed may be more relevant to that computing task than a document that was not interacted with. Different interactions with data items may be tracked to determine a relevancy of a data item. These interactions, for example, can include scrolling through a data item, highlighting content in a data item, dwelling on a data item for more than or less than a particular amount of time, sharing a data item, and the like. The sequence of interactions, including the data items interacted with, may be tracked, stored, and provided to trained transformer model 204 to generate a representation (e.g., embedding) of the sequence of interactions related to the computing task. In some examples, the generated representations may include information related to other events of the user. For example, prior interactions of the user with client device 104, computing system 102, other users, other components of system 100, and the like, may be tracked, stored, and provided to trained transformer model 204 to generate a corresponding representation related to a given request. As described herein, a data item refers to any document, file, data structure, storing data relevant to a domain. Some example documents include PDFs, WORD documents, images, webpages, videos, and the like.

Data items determined to be relevant to the execution of a particular computing task may be tagged (e.g., assigned a metadata tag indicating relevance to the computing task, class, user, etc.). When the second user is identified, the representation of the second user's corresponding request may include an indication of the data items identified as being relevant to the second user. An indication of those data items, links to those data items, and/or the actual data items, may be provided to the requesting user (e.g., the first user associated with the first request). In some examples, this may include downloading the data items to client device 104, compiling code to be used to execute the computing task, training a model to perform the computing task, and the like.

In some embodiments, computing system 102 may generate representations 116 representing the previously submitted requests using the artificial intelligence models, such as artificial intelligence model 112. For example, representations 116 may be generated using trained artificial intelligence model 204 of FIG. 2. In some embodiments, upon generation, computing system 102 may store representations 116 in database 108. In some examples, representations 116 comprise embeddings encoding information associated with the corresponding previously submitted requests.

Computing system 102 may compute a plurality of similarity scores, such as similarity scores 118 respectively associated with the plurality of representations. The similarity scores indicate a degree of similarity between first representation 114 and a corresponding representation of representations 116. In some examples, the similarity score may be a distance metric, such as an L2 distance, a Manhattan difference, and the like. The second user may be selected from amongst the users based on similarity scores 118.

In some examples, representations 116 may be ranked based on similarity scores 118 indicating the degree of similarity between first representation 114 and each of representations 116. Based on the ranking of representations 116, the corresponding users associated with each of representations 116 can be ranked based on the similarity scores. The second user can be selected based on the ranking. For example, a user having a largest similarity score with respect to the first representation may be selected (e.g., as the second user). In some examples, the second user may be selected based on the similarity score for that user's representation and first representation 114 being greater than a threshold similarity score.

In some examples, the second user may be selected based on the similarity score (e.g., indicating the degree of similarity of the first representation of the first user and the second representation of the second user) satisfying the threshold similarity condition. In some cases, satisfying the threshold similarity condition includes computing system 102 determining that a similarity score is greater than or equal to a threshold similarity score (e.g., 85% or more similarity score, 90% or more similarity score, 95% or more similarity score, etc.). As an example, a determination may be made that a similarity score representing a degree of similarity between first representation 114 associated with the first user and a second representation 120 (of representations 116) associated with the second user is greater than or equal to the threshold similarity score.

In some embodiments, the second user may be selected without computing a similarity score or based on factors other than a similarity score. For example, the second user may be selected randomly from a plurality of candidate users. Alternatively, the second user may be selected based on a particular attribute associated with the user data (e.g., a geographic location, financial services provider, university, etc.).

In some embodiments, computing system 102 may be configured to provide, to client device 104, a second representation 120 of a second request submitted by the second user. The second request may be a previously submitted request to execute a second computing task. Based on the threshold similarity condition being satisfied, however, computing system 102 may derive that the first computing task and the second computing task are the same or similar. In some examples, if no users are determined to have a similarity score that satisfies a threshold similarity condition (e.g., greatest similarity score, greater than or equal to a threshold similarity score, etc.), then no additional representations may be provided to client device 104.

Computing system 102 may also be configured to provide a data transfer program, to be executed using a decoder implemented by client device 104, to client device 104. In some examples, decoder 208 may be provided to client device 104 prior to receipt of second representation 120. For example, decoder 208 may be provided to client device 104 in response to computing system 102 receiving request 106. The data transfer program may be configured to extract second information from the second representation for executing the first computing task. In some examples, the second information may include information related to the second computing task, the identified class of the second computing task (which may be the same or different than the identified class of the first computing task), and/or the second user.

In some embodiments, computing system 102 may be configured to cause the data transfer program to be executed by client device 104 using the decoder to extract the second information from second representation 120. The data transfer program may include instructions, software, computing scripts, etc., to cause the data transfer program to be executed using hardware and/or software of client device 104. Upon extracting the second information, client device 104 may generate and send a message to computing system 102 indicating that the second information has been extracted.

In some examples, computing system 102 may receive a notification that the first user, via client device 104, has executed the first computing task after the message being received. Data representing the first computing task, the second computing task, the first user, the second user, other information, may be stored (e.g., in the database) responsive to the notification being received. Therefore, the data can be used to update the one or more artificial intelligence models. For example, if a representation (e.g., embedding) is provided to a user in response to a submitted request, and the user subsequently accessed and used the data from the provided representation when executing the computing task, this can indicate that artificial intelligence model 112, including trained classification model 202, trained transformer model 204, encoder 206, decoder 208, NLP model 210, or other models, the user's representation and the identified representation may be stored as a positive training sample for training other instances of artificial intelligence model 112. As another example, if a provided representation is not accessed and/or used when the user executes the computing task, the user's representation and identified representation may be stored as a negative training sample for training other instances of artificial intelligence model 112.

In some embodiments, computing system 102 may be configured to provide, to client device 104, a set of data items identified as being relevant to the execution of the first computing task. Computing system 102 may monitor, track, receive, and store user interaction data. The user interaction data may include data representing interactions of the second user with one or more data items while executing the second computing task. For example, the user's keystrokes, inputs, dwell times, or other interaction data, or combinations thereof, may be tracked as the user executes tasks. Data item identifiers associated with those data items, which may, for example, include web resource locations may be stored in memory. A data item that has been interacted with during the execution of a given computing task may indicate that this data item is relevant to the computing task. This rationale can be further supported by data indicating an amount of interaction that the user had with that data item. For example, a data item that was scrolled more than a threshold amount (e.g., more than 50% of the data item has been scrolled through, more than 75% of the data item has been scrolled through, and the like) may indicate that the data item was viewed contemporaneously with the execution of the first computing task. As another example, a determination may be made that, during the execution of the first computing task, a dwell time detected by a client device of a user with respect to a data item exceeded a threshold dwell time (e.g., one or more minutes, five or more minutes, ten or more minutes, etc.).

In some embodiments, computing system 102 may be configured to use the artificial intelligence models, such as artificial intelligence model 112, to compute a relevancy score indicating a relevancy of a data item to the first computing task. In some examples, the artificial intelligence models include a natural language processing model and/or one or more models programmed to perform natural language processing functionalities. For example, with reference again to FIG. 2, artificial intelligence model 112 may include a natural language processing (NLP) model 210. NLP model 210 may be trained to perform various components of NLP, such as, for example, identifying entities, performing entity resolution, identifying intents, and generating responses/performing actions based on the intents and entities. In some examples, NLP model 210 may employ one or more artificial intelligence models to extract entities, keywords, determine relationships, and concepts from the data items. Computing system 102 may be configured to compute the relevancy score by identifying, using the natural language processing model, based on the user interaction data, one or more topics associated with the data item(s). For example, a data item determined to be interacted with by a user while executing a computing task may be analyzed using NLP model 210 to extract entities, keywords, relationships, and concepts from the data item, and may determine topics related to the computing task. NLP model 210 may further be trained to determine a similarity of the first computing task to each of the one or more topics. In some embodiments, the relevancy score for a data item may be computed by determining an amount of time spent interacting with each of the one or more data items. The relevancy score for each data item may then be determined based on the amount of time.

In some embodiments, computing system 102 may be configured to assign a first tag or a second tag to each of the data items. Computing system 102 may compare the relevancy score between the data item and the first computing task to a threshold relevancy score. The first tag may be assigned to data items based on the relevancy score between the data item and the first computing task being greater than or equal to the threshold relevancy score. The second tag may be assigned to data items based on the relevancy score between the data item and the first computing task being less than the threshold relevancy score. The set of data items may include at least one of the data items that has been assigned the first tag.

In some embodiments, computing system 102 may be configured to provide the decoder, such as decoder 208, to client device 104 prior to second representation 120 being provided to client device 104. For example, decoder 208 may be provided to client device 104 in response to client device 104 notifying computing system 102 of request 106 to execute the first computing task. Decoder 208 may be trained to format the second information based on a user profile of the first user. For example, computing system 102 may retrieve user interaction data of the first user and generate the user profile based on the user interaction data. The user profile for a user may include, for example, formatting preferences for at least one of storing, presenting, or sharing the second information, parameters for executing computing tasks (e.g., libraries to load, computing resources to allocate, code to compile, etc.), or other information, or combinations thereof.

In some embodiments, user interfaces may be provided for enabling user interactions. For example, some user interfaces may include a chatbot or agent which has, or has access to, a model and/or an encoding representing another computing task or tasks and/or additional information (e.g., the second information encoded by the second representation), such as tasks performed by another user. The chatbot/agent may include logic for providing information for how to execute one or more aspects of the task. As mentioned above, the user profile for a user may include formatting preferences for at least one of storing, presenting, or sharing the second information.

In some embodiments, computing system 102 may be configured to track an amount of time that has elapsed from when second representation 120 was provided to client device 104. Computing system 102 may be configured to determine whether a predefined amount of time has elapsed from when second representation 120 being provided to client device 104 without computing system 102 receiving a notification that the second information has been extracted from second representation 120. In response to determining that the predefined amount of time has elapsed, computing system 102 may be configured to provide, to client device 104, an updated decoder re-trained based on user interactions detected subsequent to second representation being provided to client device 104 and prior to receipt of the notification. In some examples, the updated decoder may be trained using additional/updated training data comprising additional training samples. For example, positive training samples may be identified based on receiving a notification that information encoded in a provided representation was extracted therefrom. In such examples, the provided representation and a representation of a request submitted by a user prior to obtaining the provided representation may be stored as a positive training sample. On the other hand, negative training samples may be identified based on receiving a notification that the information encoded in the provided representation was not extracted, was not extracted within a predefined amount of time of the representation being provided (e.g., more than 5 seconds, more than 30 seconds, more than 60 seconds, etc.). In some cases, the lack of receipt of the notification may form the basis for identifying negative training samples. In such examples, the provided representation and a representation of a request submitted by a user prior to obtaining the provided representation may be stored as a negative training sample.

In some embodiments, more than one of representations 116 may be determined to produce a similarity score, when compared with first representation 114, that is greater than or equal to the threshold similarity score. In such cases, a representation associated with a greatest similarity score may be selected. Alternatively, multiple representations may be selected from representations 116. In this example, the selected representations may each be provided to client device 104. In some cases, the selected representations may be aggregated or otherwise combined.

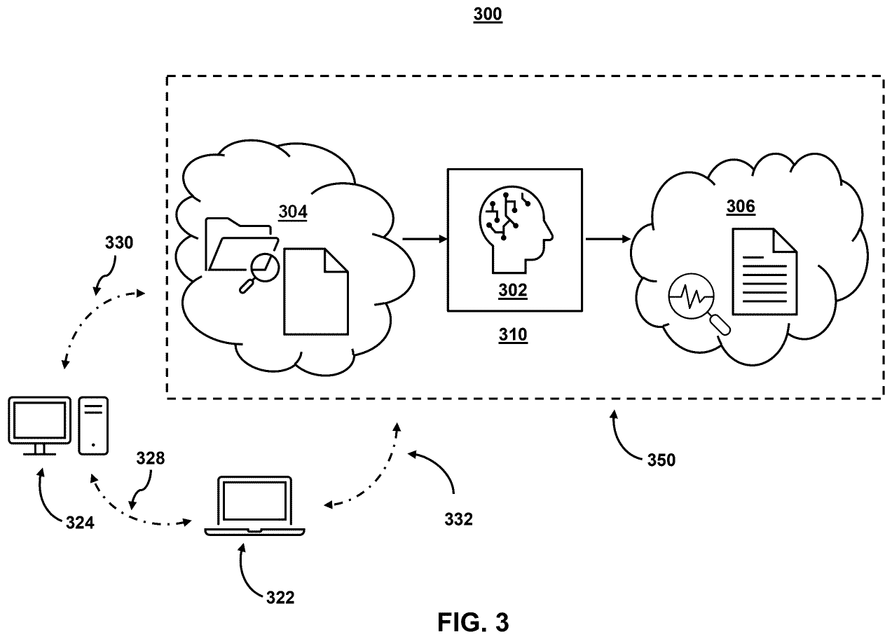

FIG. 3 shows illustrative components for a system used to facilitate user-specific data transfers to provide task-related context to a user, in accordance with one or more embodiments. For example, FIG. 3 may show illustrative components for facilitating user-specific data transfers to provide task-related context to a user. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include computing system 102, database 108, artificial intelligence model 112, or other components.

Cloud components 310 may include model 302, such as artificial intelligence model 112, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a class of computing task to be executed).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether a given input corresponds to a classification of model 302 (e.g., a data item is relevant to the computing task to be executed).

In some embodiments, the model (e.g., model 302) may automatically perform actions based on outputs 306. In some embodiments, the model (e.g., model 302) may not perform any actions. The output of the model (e.g., model 302) may be used to further update the model by generating updating training data including the input request and the predicted classification (i.e., relevant/not relevant).

The type of artificial intelligence model selected for model 302 may include, but is not limited to (which is not to suggest that any other list is limiting), any of the following: Ordinary Least Squares Regression (OLSR), Linear Regression, Logistic Regression, Stepwise Regression, Multivariate Adaptive Regression Splines (MARS), Locally Estimated Scatterplot Smoothing (LOESS), Instance-based Algorithms, k-Nearest Neighbor (KNN), Learning Vector Quantization (LVQ), Self-Organizing Map (SOM), Locally Weighted Learning (LWL), Regularization Algorithms, Ridge Regression, Least Absolute Shrinkage and Selection Operator (LASSO), Elastic Net, Least-Angle Regression (LARS), Decision Tree Algorithms, Classification and Regression Tree (CART), Iterative Dichotomizer 3 (ID3), C4.5 and C5.0 (different versions of a powerful approach), Chi-squared Automatic Interaction Detection (CHAD)), Decision Stump, M5, Conditional Decision Trees, Naive Bayes, Gaussian Naive Bayes, Causality Networks (CN), Multinomial Naive Bayes, Averaged One-Dependence Estimators (AODE), Bayesian Belief Network (BBN), Bayesian Network (BN), k-Means, k-Medians, K-cluster, Expectation Maximization (EM), Hierarchical Clustering, Association Rule Learning Algorithms, A-priori algorithm, Eclat algorithm, Artificial Neural Network Algorithms, Perceptron, Back-Propagation, Hopfield Network, Radial Basis Function Network (RBFN), Deep Learning Algorithms, Deep Boltzmann Machine (DBM), Deep Belief Networks (DBN), Convolutional Neural Network (CNN), Deep Metric Learning, Stacked Auto-Encoders, Dimensionality Reduction Algorithms, Principal Component Analysis (PCA), Principal Component Regression (PCR), Partial Least Squares Regression (PLSR), Collaborative Filtering (CF), Latent Affinity Matching (LAM), Cerebri Value Computation (CVC), Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA), Ensemble Algorithms, Boosting, Bootstrapped Aggregation (Bagging), AdaBoost, Stacked Generalization (blending), Gradient Boosting Machines (GBM), Gradient Boosted Regression Trees (GBRT), Random Forest, Computational intelligence (evolutionary algorithms, etc.), Computer Vision (CV), Natural Language Processing (NLP), Recommender Systems, Reinforcement Learning, Graphical Models, or separable convolutions (e.g., depth-separable convolutions, spatial separable convolutions, etc.), Transformer Models, Large Language Models (LLMs), or others.

System 300 also includes API layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

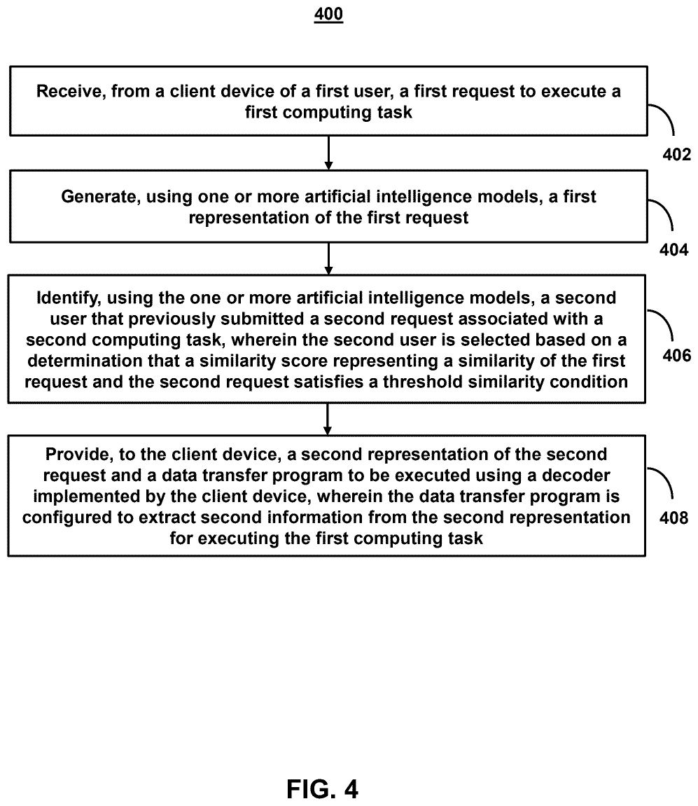

FIG. 4 shows a flowchart of a process 400 including steps involved in facilitating user-specific data transfers to provide task-related context to a user, in accordance with one or more embodiments. For example, system 100 of FIG. 1 may use process 400 (e.g., as implemented on one or more system components described above) in order to facilitate user-specific data transfers to provide task-related context to a user.

At step 402, a first request to execute a first computing task may be received from a client device of a first user. For example, computing system 102 may receive request 106 from client device 104 associated with a first user. In some examples, request 106 may be a request for a first computing task to be executed (e.g., to execute a script, format an application, retrieve data items, compile code, etc.). In some embodiments, request 106 may include information regarding one or more interactions of the user with client device 104. For example, interactions of the user with various data items, such as scrolling through data items, dwelling on portions of data items, sharing data items, and the like, may be monitored and stored in associated with a profile of the user. In some examples, additional information, such as device OS details, device hardware specifications, and the like, may be included within data packets submitted to computing system 102 with request 106. It should be noted that the monitoring and tracking of user interactions with data items may be performed with consent from the user, who may also request to have such interactions no longer tracked.

At step 404, a first representation of the first request may be generated using one or more artificial intelligence models. For example, computing system 102 may generate first representation 114 representing request 106 using artificial intelligence model 112. In some embodiments, the artificial intelligence models may include a trained transformer model, such as trained transformer model 204. Computing system 102 may use trained transformer model 204 to generate first representation 114 (e.g., a first embedding) representing request 106. In some cases, trained transformer model 204 includes an encoder, such as encoder 206. Computing system 102 may use encoder 206 to encode first information associated with the first request. The first information may include the first computing task and the first user (and/or information related to the first computing task, the first user, and the like). Artificial intelligence model 112 may also include trained classification model 202 used to determine a class associated with the first computing task. First representation 114 can encode the class and/or information associated with the class (e.g., a class identifier, one or more attributes of the class, one or more related classes). In some embodiments, to determine the class, computing system 102 may be configured to identify a task type of the first computing task (e.g., to execute a script, format an application, retrieve data items, compile code, etc.). Computing system 102 may select the class based on the identified task type of the first computing task. For example, a first task type can indicate that a given computing task is to be classified into a first class, a second task type can indicate that a given computing task is to be classified into a second class, and the like. In some examples, a given class may include one or more task types of computing tasks.

At step 406, a second user may be identified using the artificial intelligence models. The second user may correspond to a user that, via their respective client device, previously submitted a second request associated with a second computing task. The second user can be selected based on a determination that a similarity score representing a similarity of the first representation representing the first request and a second representation of the second request satisfies a threshold similarity condition. For instance, when the similarity score satisfies the threshold similarity condition, this can indicate that the first computing task and the second computing task are the same (or similar). In some embodiment, a plurality of representations (e.g., representations 116) representing a plurality of previously submitted requests from a plurality of users may be retrieved. Each of representations 116 may be generated, for example, using the artificial intelligence models (e.g., each representation may be an embedding representing a corresponding request). Similarity scores 118 may indicate a degree of similarity between first representation 114 and each of representations 116. In some examples, the similarity score may be a distance metric, such as an L2 distance, a Manhattan difference, and the like. The second user may be selected from amongst the users based on the similarity scores. In some examples, representations 116 may be ranked based on the degree of similarity. The second user can be selected based on the ranking. For example, a user having a largest similarity score with respect to the first representation may be selected. In some examples, the second user may be selected based on the similarity score satisfying the threshold similarity condition. For example, satisfying the threshold similarity condition includes computing system 102 determining that the similarity score is greater than or equal to a threshold similarity score (e.g., 85% or more similarity score, 90% or more similarity score, 95% or more similarity score, etc.).

At step 408, a second representation of the second request and a data transfer program to be executed using a decoder implemented by the client device may be provided to the client device. For example, second representation 120 may be provided to client device 104 to facilitate execution of the first computing task. The data transfer program may be configured to extract second information from second representation 120 for executing the first computing task. Computing system 102 may effectuate execution of the data transfer program by client device 104 using the decoder (e.g., decoder 208) to extract the second information. The data transfer program may include instructions, software, computing scripts, etc., to cause the data transfer program to be executed using hardware and/or software of client device 104. Upon extracting the second information, client device 104 may generate and send a message to computing system 102 indicating that the second information has been extracted. In some examples, computing system 102 may receive a notification that the first user has executed the first computing task subsequent to the message being received. Data representing the first computing task, the second computing task, the first user, the second user, other information, or combinations thereof, may be stored (e.g., in the database). In some examples, the data can be used to update artificial intelligence model 112.

In some embodiments, computing system 102 may be configured to provide, to client device 104, a set of data items identified as being relevant to executing the first computing task. Computing system 102 may monitor, track, receive, and store user interaction data. The user interaction data may include data representing interactions of the second user with one or more data items while executing the first computing task. For example, the user's keystrokes, inputs, dwell times, or other interaction data, or combinations thereof, may be tracked as the user executes tasks. Data item identifiers associated with those data items, which may, for example, include web resource locations may be stored in memory. A data item that has been interacted with during the execution of a given computing task may indicate that the data item may be relevant to the computing task. This rationale can be further supported by data indicating an amount of interaction that the user had with that data item. For example, a data item that has been scrolled more than a threshold amount (e.g., more than 50% of the data item has been scrolled through, more than 75% of the data item has been scrolled through, and the like) may indicate that the data item was viewed contemporaneously with the execution of the first computing task. As another example, a determination may be made that, during the execution of the first computing task, a dwell time detected by a client device of a user with respect to a data item exceeded a threshold dwell time (e.g., one or more minutes, five or more minutes, ten or more minutes, etc.).

In some embodiments, computing system 102 may be configured to use the artificial intelligence models to compute a relevancy score indicating a relevancy of a data item to the first computing task. In some examples, the artificial intelligence models include a natural language processing model and/or one or more models programmed to perform natural language processing functionalities. Computing system 102 may be configured to compute the relevancy score by identifying, using the natural language processing model, based on the user interaction data, one or more topics associated with the interactions. The natural language processing model may be used to determine a similarity of the first computing task to each of the one or more topics. In some embodiments, the relevancy score for a data item may be computed by determining an amount of time spent interacting with each of the one or more data items. The relevancy score for each data item may then be determined based on the amount of time.

In some embodiments, computing system 102 may be configured to assign a first tag or a second tag to each of the data items. Computing system 102 may compare the relevancy score between the data item and the first computing task to a threshold relevancy score. The first tag may be assigned to data items based on the relevancy score between the data item and the first computing task being greater than or equal to the threshold relevancy score. The second tag may be assigned to data items based on the relevancy score between the data item and the first computing task being less than the threshold relevancy score. The set of data items may include at least one of the data items that has been assigned the first tag.

In some embodiments, computing system 102 may be configured to provide the decoder to client device 104 prior to the second representation being provided. For example, the decoder may be provided to client device 104 in response to client device 104 notifying computing system 102 of the request to execute the first computing task. The decoder may be trained to format the second information based on a user profile of the first user. Computing system 102 may retrieve user interaction data of the first user and generate the user profile based on the user interaction data. The user profile for a user may include, for example, formatting preferences for at least one of storing, presenting, or sharing the second information, parameters for executing computing tasks (e.g., libraries to load, computing resources to allocate, code to compile, etc.), or other information, or combinations thereof.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for facilitating user-specific data transfers to provide task-related context to a user.
2. The method of embodiment 1, comprising: receiving, from a client device of a first user, a first request to execute a first computing task; generating, using one or more artificial intelligence models, a first representation of the first request; identifying, using the one or more artificial intelligence models, a second user that previously submitted a second request associated with a second computing task, wherein the second user is selected based on a determination that a similarity score representing a similarity of the first representation to a second representation of the second request satisfies a threshold similarity condition; and providing, to the client device, the second representation and a data transfer program to be executed using a decoder implemented by the client device, wherein the data transfer program is configured to cause second information to be extracted from the second representation for executing the first computing task.
3. The method of embodiment 2, wherein the one or more artificial intelligence models comprises a trained classification model.
4. The method of embodiment 3, further comprising: determining, using the trained classification model, a class associated with the first computing task.
5. The method of embodiment 4, wherein the first representation encodes the class associated with the first computing task.
6. The method of embodiment 4 or 5, wherein determining the class comprises: identifying a task type of the first computing task; and selecting the class based on the identified task type of the first computing task.
7. The method of any one of embodiments 2-6, wherein the one or more artificial intelligence models comprises a trained transformer model.
8. The method of embodiment 7, wherein generating the first representation of the first request comprises: generating, using the trained transformer, a first embedding representing the first request.
9. The method of embodiment 8, wherein the trained transformer model comprises an encoder.
10. The method of embodiment 9, wherein generating the first embedding comprises: encoding, using the encoder, first information associated with the first request to obtain the first embedding.
11. The method of embodiment 10, wherein the first information comprises information related to at least one of the first computing task or the first user.
12. The method of any one of embodiments 2-11, wherein identifying the second user comprises retrieving a plurality of representations representing a plurality of previously submitted requests from a plurality of users; computing a plurality of similarity scores respectively associated with the plurality of representations; and selecting the second user from the plurality of users based on the plurality of similarity scores.
13. The method of embodiment 12, wherein each of the plurality of representations is generated using the one or more artificial intelligence models.
14. The method of embodiment 12 or 13, wherein each of the similarity scores indicates a degree of similarity between the first representation and a corresponding representation of the plurality of representations
15. The method of any one of embodiments 12-14, wherein selecting the second user comprises: ranking the plurality of representations based on the degree of similarity between the first representation and each corresponding representation of the plurality of representations, wherein the second user is selected based on the ranking.
16. The method of any one of embodiments 12-14, wherein selecting the second user comprises: selecting the second user based on the similarity score satisfying the threshold similarity condition.
17. The method of embodiment 16, wherein satisfying the threshold similarity condition comprises: determining that the similarity score is greater than or equal to a threshold similarity score.
18. The method of any one of embodiments 2-17, further comprising: causing the data transfer program to be executed using the decoder to extract the second information; and receiving, from the client device, a message indicating that the second information has been extracted.
19. The method of embodiment 18, further comprising: receiving a notification that the first user has executed the first computing task subsequent to the message being received; and storing the first representation and the second representation as a positive training sample to update the one or more artificial intelligence models.
20. The method of embodiment 18 or 19, further comprising: receiving a notification that the first user failed to execute the task subsequent to the message being received or failing to receive the notification within a threshold amount of time of the second representation being provided; and storing the first representation and the second representation as a negative training sample to update the one or more artificial intelligence models.
21. The method of any one of embodiments 2-20, further comprising: providing, to the client device, a set of data items identified as being relevant to executing the first computing task.
22. The method of embodiment 21, wherein providing the set of data items comprises: receiving user interaction data comprising interactions of the second user with one or more data items while executing the first computing task; computing, using the one or more artificial intelligence models, a relevancy score indicating a relevancy of each of the one or more data items to the first computing task; and assigning a first tag or a second tag to each of the one or more data items.
23. The method of embodiment 21, wherein the set of data items comprises at least one of the one or more data items assigned the first tag.
24. The method of embodiment 22 or 23, wherein assigning the first tag or the second tag comprises: comparing the relevancy score between the data item and the first computing task to a threshold relevancy score.
25. The method of embodiment 24, wherein the first tag is assigned to data items based on the relevancy score between the data item and the first computing task being greater than or equal to the threshold relevancy score, and the second tag is assigned to the data items based on the relevancy score between the data item and the first computing task being less than the threshold relevancy score.
26. The method of any one of embodiments 22-25, wherein the one or more artificial intelligence models comprise a natural language processing model.
27. The method of embodiment 26, wherein computing the relevancy score comprises: identifying, using the natural language processing model, based on the user interaction data, one or more topics associated with the one or more data items; and determining, using the natural language processing model, a similarity of the first computing task to each of the one or more topics.
28. The method of any one of embodiments 22-27, wherein computing the relevancy score comprises: determining an amount of time spent interacting with each of the one or more data items, wherein the relevancy score for each data item is based on the amount of time.
29. The method of embodiment 2-28, further comprising: providing the decoder to the client device prior to the second representation being provided, wherein the decoder is trained to format the second information based on a user profile of the first user.
30. The method of embodiment 29, further comprising: retrieving user interaction data of the first user; and generating the user profile based on the user interaction data.
31. The method of embodiment 30, wherein the user profile comprises formatting preferences for at least one of storing, presenting, or sharing the second information.
32. The method of any one of embodiments 2-31, further comprising: determining that a predefined amount of time has elapsed from the second representation being provided to the client device without receipt of a notification that the second information has been extracted from the second representation; and providing, to the client device, an updated decoder re-trained based on user interactions detected subsequent to the second representation being provided to the client device and prior to receipt of the notification.
33. A method comprising: receiving, from a client device of a first user, a first request to execute a first computing task; determining, using a trained classification model, a first class associated with the first computing task, the first class indicating a task type of the first computing task; generating, using a trained transformer model, a first embedding representing the first request, wherein the first embedding encodes first information comprising the first computing task, the first class, and the first user; computing, using the trained transformer model, a plurality of similarity scores each representing a similarity between the first request and a plurality of previously submitted requests from a plurality of users, wherein each of the plurality of previously submitted requests comprises a request to execute a respective computing task; identifying, using the trained transformer model, a second user from the plurality of users based on a similarity score of the plurality of similarity scores exceeding a predefined threshold similarity score, the similarity score representing a similarity between the first request and a second request received from the second user to execute a second computing task, wherein the similarity score exceeding the predefined threshold similarity score indicates that the trained classification model classified the second computing task into the first class; retrieving, using the trained transformer model, a second embedding representing the second request, wherein the second embedding encodes second information comprising the second computing task, the first class, and the second user; providing the second embedding to the client device; and executing, using a decoder implemented by the client device, a data transfer program to extract the second information from the second embedding and store, in memory, the second information, wherein the first computing task is executed using at least some of the second information.
34. One or more non-transitory, computer-readable mediums storing instructions that, when executed by a data processing apparatus, cause the data processing apparatus to perform operations comprising those of any of embodiments 1-33.
35. A system comprising one or more processors; and memory storing instructions that, when executed by the processors, cause the processors to effectuate operations comprising those of any of embodiments 1-33.
36. A system comprising means for performing any of embodiments 1-33.

What is claimed is:

1. A system for facilitating user-specific data transfers to provide task-related context to a user, the system comprising:
one or more processors programmed to:
receive, from a client device of a first user, a first request to execute a first computing task;
determine, using a trained classification model, a first class associated with the first computing task, the first class indicating a task type of the first computing task;
generate, using a trained transformer model, a first embedding representing the first request, wherein the first embedding encodes first information comprising the first computing task, the first class, and the first user;
compute, using the trained transformer model, a plurality of similarity scores each representing a similarity between the first embedding and a plurality of embeddings respectively representing a plurality of previously submitted requests from a plurality of users, wherein each of the plurality of previously submitted requests comprises a request to execute a respective computing task;
identify, using the trained transformer model, a second user from the plurality of users based on a similarity score of the plurality of similarity scores exceeding a predefined threshold similarity score, the similarity score representing a similarity between the first embedding and a second embedding of the plurality of embeddings representing a second request of the second user to execute a second computing task, wherein the similarity score exceeding the predefined threshold similarity score indicates that the trained classification model classified the second computing task into the first class;
retrieve, using the trained transformer model, the second embedding representing the second request, wherein the second embedding encodes second information comprising the second computing task, the first class, and the second user;
provide the second embedding to the client device; and
execute, using a decoder implemented by the client device, a data transfer program to extract the second information from the second embedding and store, in memory, the second information, wherein the first computing task is executed using at least some of the second information.

2. A method, comprising:
receiving, from a client device of a first user, a first request to execute a first computing task;
generating, using one or more artificial intelligence models, a first representation of the first request;
identifying, using the one or more artificial intelligence models, a second user that previously submitted a second request associated with a second computing task, wherein the second user is selected based on a determination that a similarity score representing a similarity of the first representation to a second representation of the second request satisfies a threshold similarity condition; and
providing, to the client device, the second representation and a data transfer program to be executed using a decoder implemented by the client device, wherein the data transfer program is configured to cause second information to be extracted from the second representation for executing the first computing task.

3. The method of claim 2, wherein the one or more artificial intelligence models comprises a trained classification model, the method further comprises:
determining, using the trained classification model, a class associated with the first computing task, wherein the first representation encodes the class associated with the first computing task.

4. The method of claim 3, wherein determining the class comprises:
identifying a task type of the first computing task based on the first request; and
selecting the class based on the identified task type of the first computing task.

5. The method of claim 2, wherein the one or more artificial intelligence models comprises a trained transformer model, generating the first representation of the first request comprises:
generating, using the trained transformer model, a first embedding representing the first request.

6. The method of claim 5, wherein the trained transformer model comprises an encoder, generating the first embedding comprises:
encoding, using the encoder, first information associated with the first request to obtain the first embedding, the first information comprising information related to at least one of the first computing task or the first user.

7. The method of claim 2, wherein identifying the second user comprises:
retrieving a plurality of representations representing a plurality of previously submitted requests from a plurality of users, wherein each of the plurality of representations is generated using the one or more artificial intelligence models;
computing a plurality of similarity scores respectively associated with the plurality of representations, wherein each of the plurality of similarity scores indicates a degree of similarity between the first representation and a corresponding representation of the plurality of representations; and
selecting the second user from the plurality of users based on the plurality of similarity scores.

8. The method of claim 7, wherein selecting the second user comprises:
ranking the plurality of representations based on the degree of between the first representation and each corresponding representation of the plurality of representations, wherein the second user is selected based on the ranking.

9. The method of claim 7, wherein selecting the second user comprises:
selecting the second user based on the similarity score satisfying the threshold similarity condition, wherein satisfying the threshold similarity condition comprises:
determining that the similarity score is greater than or equal to a threshold similarity score.

10. The method of claim 2, further comprising:
causing the data transfer program to be executed using the decoder to extract the second information; and
receiving, from the client device, a message indicating that the second information has been extracted.

11. The method of claim 10, further comprising:
receiving a notification that the first user has executed the first computing task subsequent to the message being received; and
storing the first representation and the second representation as a positive training sample to update the one or more artificial intelligence models.

12. The method of claim 2, further comprising:
providing, to the client device, a set of data items identified as being relevant to executing the first computing task.

13. The method of claim 12, wherein providing the set of data items comprises:
receiving user interaction data comprising interactions of the second user with one or more data items during execution of the first computing task;
computing, using the one or more artificial intelligence models, a relevancy score indicating a relevancy of each of the one or more data items to the first computing task; and
assigning a first tag or a second tag to each of the one or more data items, wherein the set of data items comprises at least one of the one or more data items assigned the first tag.

14. The method of claim 13, wherein assigning the first tag or the second tag comprises:
comparing the relevancy score between each data item from the set of data items and the first computing task to a threshold relevancy score, wherein the first tag is assigned to data items based on the relevancy score between the data items and the first computing task being greater than or equal to the threshold relevancy score, and the second tag is assigned to the data items based on the relevancy score between the data items and the first computing task being less than the threshold relevancy score.

15. The method of claim 13, wherein the one or more artificial intelligence models comprise a natural language processing model, computing the relevancy score comprises:
identifying, using the natural language processing model, one or more topics associated with the one or more data items; and
determining, using the natural language processing model, a similarity of the first computing task to each of the one or more topics to compute the relevancy score.

16. The method of claim 13, wherein computing the relevancy score comprises:
determining an amount of time spent interacting with each of the one or more data items, wherein the relevancy score for each data item is based on the amount of time.

17. The method of claim 2, further comprising:
providing the decoder to the client device prior to the second representation being provided, wherein the decoder is trained to format the second information based on a user profile of the first user.

18. The method of claim 17, further comprising:
retrieving user interaction data of the first user; and
generating the user profile based on the user interaction data, wherein the user profile comprises formatting preferences for at least one of storing, presenting, or sharing the second information.

19. The method of claim 2, further comprising:
determining that a predefined amount of time has elapsed from the second representation being provided to the client device without receipt of a notification that the second information has been extracted from the second representation; and
providing, to the client device, an updated decoder re-trained based on user interactions detected subsequent to the second representation being provided to the client device and prior to receipt of the notification.

20. One or more non-transitory computer-readable media storing computer program instructions that, when executed by one or more processors, effectuate operations comprising:
receiving, from a client device of a first user, a first request to execute a first computing task;
generating, using one or more artificial intelligence models, a first representation of the first request;
identifying, using the one or more artificial intelligence models, a second user that previously submitted a second request associated with a second computing task, wherein the second user is selected based on a determination that a similarity score representing a similarity of the first representation to a second representation of the second request satisfies a threshold similarity condition; and
providing, to the client device, the second representation and a data transfer program to be executed using a decoder implemented by the client device, wherein the data transfer program is configured to cause second information to be extracted from the second representation for executing the first computing task.
